(19) United States
(12) Patent Application Publication
(10) Pub. No.: US 2002/0158127 A1
(43) Pub. Date: Oct. 31, 2002

(54) Matrix code reader

(75) Inventors: Toshikazu Hori, Milpitas, CA (US); Kenji Tashiro, Sunnyvale, CA (US)

Correspondence Address: LAW OFFICES OF THOMAS E. SCHATZEL, A Professional Corporation, Suite 240, 16400 Lark Avenue, Los Gatos, CA, 95032-2547, US

(73) Assignee: PULNIX AMERICA, INC.

(21) Appl. No.: 09/847,000

(22) Filed: Apr. 30, 2001

(51) Int. Cl. G06K 7/10; G06K 7/14

(52) U.S. Cl. 235/454

(57) ABSTRACT

A matrix code reader comprises a camera-on-a-chip CMOS image sensor with a global-shutter and window-of-interest constraints. The CMOS image code reader is mounted in a handheld or stationary unit that also include a local display screen, a microprocessor, and a serial communications interface. A trigger allows a user to signal the microprocessor to capture the visual scene being imaged by the CMOS image sensor when the local display screen indicates a properly framed image.

### FIELD OF THE INVENTION

The present invention relates to electronic imaging devices, and more particularly to cameras that efficiently capture matrix code images.

### DESCRIPTION OF THE PRIOR ART

Bar codes on products and bar-code code readers at the check-out stands are now ubiquitous in American retail stores. These familiar systems use a one-dimension code format that looks like a group of parallel lines with small variations in the line thickness and spacing. The bar codes have only to encode a relatively small amount of data, e.g., the universal product code (UPC) or store “SKU” number. Typical bar-code readers sweep a single laser beam across the printed bar code and read the digital variations that occur in the reflected light.

Much more data can be encoded in two-dimension “matrix” code formats. Symbol Technologies (Bohemia, N.Y.) has developed and markets an extensive product offering related to two-dimensional bar-code symbols. U.S. Pat. No. 5,243,655, issued Sep. 7, 1993, to Ynjiun Wang, describes a system for encoding and decoding data in machine-readable graphics. Optical scanning is used to read the two-dimensional bar-code symbols, for example a laser light beam is swept in a raster pattern. The trouble with this is if the object and the code reader are moving relative to one another, the raster return signal will have spatially generated distortions. These distortions can confuse and interfere with the decoders.

Only the actual two-dimensional bar-code symbol in the field of view of the code reader is of interest. Such symbol can have a variety of orientations, sizes, and distortions in the overall field of view that depend on the relative positions of the object and code reader, and also the optical system involved. U.S. Pat. No. 5,304,787, issued Apr. 19, 1994, to Ynjian Wang, describes methods for locating such two-dimensional bar codes. Once the bar code image is parsed, the decoding can proceed. An image buffer is used to store the whole image scanned. The bar code image is included somewhere within this whole image. Sampling, analysis, and correlating processes are used to draw a bounding box that minimally comprises all of the bar code image.

Frederick Schuessler, et al., suggest using CCD imaging cameras to scan bar codes in U.S. Pat. No. 6,047,892, issued Apr. 11, 2000. Such Patent reviews prior art one-dimension and two-dimension bar code formats that are in widespread use.

Jerome Drexler describes a method and system for laser writing microscopic data spots on cards and labels readable with a linear CCD array, in U.S. Pat. No. 6,145,742, issued Nov. 14, 2000. Such system is said to be able to store as much as 500 times what the widely adopted PDF417 two-dimensional bar code can store. Optical storage media is used to host an array of microscopic data spots. The storage media is moved orthogonal to the linear CCD array so the whole field of data storage can be read in. This requires that the orientation and optics be tightly controlled, and a free-hand use of such system with a handheld code reader is probably not practical.

Prior art bar-code scanning technologies suffer from not being fast enough to “stop” all movement in an image exposure. The faster the relative movement between the object and the camera, and the finer the image resolution required, the quicker the shutter speed must be. Once the image is captured, conventional techniques seem to be up to the job of parsing the region-of-interest and resolving random image orientations.

Many of the commercial units being marketed do not provide any means of displaying the area being scanned or for showing any data that has been interpreted from the scan. They instead have sounders that beep different tones depending on whether a snapshot has captured the bar code or data matrix properly. Sometimes several attempts are needed because the image got blocked or was blurred by relative velocities, vibration, or optics.

### SUMMARY OF THE INVENTION

It is therefore an object of the present invention to provide a matrix code reader that can capture a video image with a two-dimensional optical bar code.

It is another object of the present invention to provide a matrix code reader with a fast enough shutter to stop relative motion and prevent image distortions.

Briefly, a matrix code reader embodiment of the present invention comprises a camera-on-a-chip CMOS image sensor with a global-shutter and window-of-interest constraints. The CMOS image code reader is mounted in a handheld or stationary unit that also includes a local display screen, a microprocessor, and a serial communications interface. A trigger allows a user to signal the microprocessor to capture the visual scene being imaged by the CMOS image sensor when the local display screen indicates a properly framed image.

An advantage of the present invention is that a matrix code reader is provided that can scan two-dimensional bar codes.

Another advantage of the present invention is that a matrix code reader is provided that captures the desired information quickly and reliably.

These and other objects and advantages of the present invention will no doubt become obvious to those of ordinary skill in the art after having read the following detailed description of the preferred embodiments which are illustrated in the drawing figure.

### IN THE DRAWINGS

FIG. 1 is a functional block diagram of a matrix code reader embodiment of the present invention; and

FIG. 2 is a left side diagram of a matrix code reader embodiment of the present invention.

### DETAILED DESCRIPTION OF THE PREFERRED EMBODIMENT

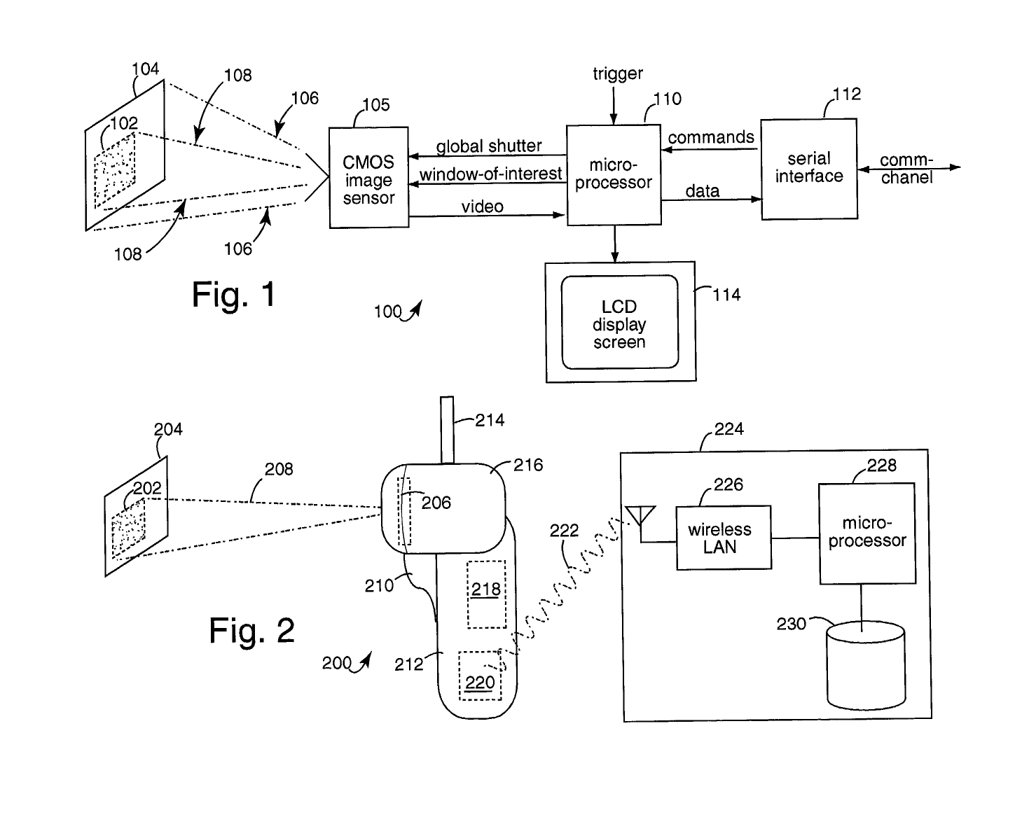

A matrix code reader embodiment of the present invention is illustrated in FIG. 1 and is referred to herein by the general reference numeral 100. A matrix code tag 102 is printed on a large object 104 and encodes information about the object, e.g., sales price, serial number, date-of-manufacture, source, destination, airbill, tax ID, contents, materials, warnings, etc. For example, such coding is in two-dimensional bar code, e.g., as popularized by Symbol Technologies (Bohemia, N.Y.), Metanetics (Fort Meyers, Fla.), and others. A CMOS image sensor 105 has the object 104 in a field-of-view 106. Inside that, is a window-of-interest 108 that spans just the visual image of the matrix code tag 102.

The CMOS image sensor 105 must be a type that includes a so-called “global shutter” which exposes and latches all imager pixels instantly in parallel. This is needed to photographically stop any action in the field-of-view 106. The only such devices known to be acceptable are jointly manufactured by Kodak and Motorola, e.g., Kodak KAC-0310 or KAC-1310, and Motorola SCM20014. It is preferred that such CMOS image sensor 105 also have window-of-interest controls that constrain any video output to just the window-of-interest 108, and therefore save processing resources from being wasted on other images in the field-of-view 106. The Kodak and Motorola products mentioned have three registers that are loaded with digital values for the corner position, column-count width, and row-count height.

A microprocessor 110 provides such global-shutter and window-of-interest controls according to user-supplied operational requirements, e.g., a trigger and user preferences. A video output is received from the CMOS image sensor 105 that is formatted for serial transmission by a serial interface 112. The video output is also formatted for display on a liquid crystal display (LCD) 114 for local viewing. Such LCD 114 provides feedback to a user so that the CMOS image sensor 105 can be positioned best to capture the matrix code tag 102. The LCD 114 displays messages from the microprocessor 110 that interpret data that has been decoded from the image obtained from the matrix code tag 102. Such messages and displays can also be sourced from a remote computer via the serial interface 112, e.g., to display interpretations that have been remotely decoded.

The window-of-interest controls are easiest to implement if fixed after brief experimentation, but some applications will benefit if these window-of-interest controls are dynamically generated by continual analyses of the field-of-view 106 by the microprocessor 110 or a remote computer.

The serial interface 112 comprises standard personal computer (PC) electrical interfaces, cables and connectors, such as DB-9 connectors with RS-232 interfaces, or universal serial bus (USB), etc. Alternatively, the serial interface 112 can comprise IEEE 802.11a wireless local area network (LAN) components.

The encoding and decoding of the matrix code tag 102 is done using conventional methods and devices. Embodiments of the present invention capture images of the matrix code tag 102 by restricting the image captured and processed to the window-of-interest and using a global shutter. Such embodiments further comprise local video displays to guide the user by providing useful operational feedback.

FIG. 2 illustrates a handheld reader embodiment of the present invention, and is referred to herein by the general reference numeral 200. In general, the reader 200 resembles the Metanetics IR-2000 handheld image reader, e.g., as marketed in the United States by Metanetics, Inc. (Fort Meyers, Fla.). The reader 200 is aimed at a matrix code tag 202 attached to a package 204. The tag encodes information related to the package. An image sensor 206 is pointed by a user at the tag 202 such that a window-of-interest 208 includes a visual image of the matrix code tag 202. A trigger 210 on a grip 212 is pulled when the user can see an image of the tag that has been repeated in a small, flat-panel LCD screen 214. A top end 216 encloses the image sensor 206. A microcomputer 218 controls both the image sensor 206 and LCD screen 214. It takes input from the trigger 210.

A radio communications transceiver 220 allows for wireless communication over a radio link 222 with a centralized system 224. For example, a wireless LAN 226 allows ETHERNET-type networking with a microprocessor 228 connected to a database 230. Measurements obtained from the handheld reader 200 are received, interpreted, and stored by the centralized system 224. Instructions, information, and/or graphics are returned to the user to be viewed on the LCD screen 214. These will relate to how the tag 202 has been understood and what is to be done with the package 204.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. An image reader, comprising:
a portable housing for operation in sight of a data-encoded tag;
an image sensor disposed in a forward part of the portable housing and having a video output;
a global shutter included in the image sensor for photographically stopping an entire scene viewed by the image sensor and converted to a video output signal;
a local flat-panel display screen attached to the portable housing and providing for a display to guide user operation or data reading of data coded tag; and
a microprocessor connected to said video output of the image sensor, the global shutter, and the local flat-panel display screen, and providing for the capture and interpretation of said data-encoded tag when optically viewed by the image sensor.

2. The image reader of claim 1, further comprising:
a trigger switch connected to signal the microprocessor when the global shutter is to be operated and an image of said data-encoded tag is to be interpreted.

3. The image reader of claim 1, further comprising:
a window-of-interest control included in the image sensor and controlled by the microprocessor;
wherein said video output signal is constrained to substantially include only a representation of said data-encoded tag.

4. A data-image reader system, comprising:
a graphic that includes encoded data that can be optically read, and further providing for attachment to an object that is a subject of said encoded data;
a portable housing for operation by a user within visual range of the graphic;
an image sensor disposed in a forward part of the portable housing and having a video output signal;
a global shutter included in the image sensor for capturing clear images of the graphic when moving;
a local flat-panel display screen attached to the portable housing and having a video input, and providing for the display of a feedback image to guide a user in imaging the graphic; and
a microprocessor connected to receive said video output signal, to control the global shutter, and to drive said video input of the local flat-panel display screen;
wherein, a video image of the graphic is captured and interpreted to provide decoded data associated with said object.

5. The image reader of claim 4, further comprising:
a trigger switch connected to signal the microprocessor when the global shutter is to be operated and an image of said data-encoded tag is to be interpreted.

6. The image reader of claim 4, further comprising:
a window-of-interest control included in the image sensor and controlled by the microprocessor;
wherein said video output signal is constrained to substantially include only a representation of said data-encoded tag.

7. A data-image reader system, comprising:
a graphic that includes encoded data that can be optically read, and further providing for attachment to an object that is a subject of said encoded data;
a portable housing for operation by a user within visual range of the graphic;
an image sensor disposed in a forward part of the portable housing and having a video output signal;
a global shutter included in the image sensor for capturing clear images of the graphic when moving;
a local flat-panel display screen attached to the portable housing and having a video input, and providing for the display of a feedback image to guide a user in imaging the graphic;
a microprocessor connected to receive said video output signal, to control the global shutter, and to drive said video input of the local flat-panel display screen;
a trigger switch connected to signal the microprocessor when the global shutter is to be operated and an image of said data-encoded tag is to be interpreted; and
a window-of-interest control included in the image sensor and controlled by the microprocessor, and providing for a constraint of said video output signal to substantially include only a representation of said data-encoded tag;
wherein, a video image of the graphic is captured and interpreted to provide decoded data associated with said object.
